(19) United States
(12) Patent Application Publication
(10) Pub. No.: US 2007/0206741 A1
(43) Pub. Date: Sep. 6, 2007

(54) Method and apparatus for monitoring network activity

(75) Inventors: Dianna I. Tiliks, Palatine, IL (US); Wayne R. Heinmiller, Elgin, IL (US); Carol S. Gruchala, Naperville, IL (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/366,922

(22) Filed: Mar. 1, 2006

(51) Int. Cl. H04M 11/00

(52) U.S. Cl. 379/106.02

(57) ABSTRACT

A method (200) and apparatus (102, 108) are disclosed for monitoring network activity. An apparatus that incorporates teachings of the present disclosure may include, for example, an activity notification system (ANS) (102) having a controller (104) that manages operations of a communications interface (110) for communicating with network elements (101) in a communication system. The controller can be programmed to monitor (202) network activities associated with a plurality of communication devices of an end user, generate (204) from the monitored activities an end user profile that predicts a behavior of the end user, and transmit (212, 222) a notice when a change in the monitored activities differs from a behavior predicted by the end user profile. Additional embodiments are disclosed.

### FIELD OF THE DISCLOSURE

The present disclosure relates generally to activity detection techniques, and more specifically to a method and apparatus for monitoring network activity.

### BACKGROUND

As landline and wireless communication services become ubiquitous, monitoring the location and activities of end users becomes easier. These improvements can be helpful to end users as well as pose an economic security risk.

A need therefore arises for a method that protects the end user's interests without burdening the end user's exploitation of advancements in the art.

### BRIEF DESCRIPTION OF THE DRAWINGS

FIG. 1 depicts an exemplary embodiment of an activity notification system (ANS) monitoring anomalous behavior of one or more communication devices of an end user operating in a communication system;

FIG. 2 depicts an exemplary method operating in the ANS and the monitored communication devices; and

FIG. 3 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method and apparatus for monitoring network activity.

In a first embodiment of the present disclosure, an activity notification system (ANS) can have a controller that manages operations of a communications interface for communicating with network elements in a communication system. The controller can be programmed to monitor network activities associated with a plurality of communication devices of an end user, generate from the monitored activities an end user profile that predicts a behavior of the end user, and transmit a notice when a change in the monitored activities differs from a behavior predicted by the end user profile.

In a second embodiment of the present disclosure, a computer-readable storage medium in an activity notification system (ANS) can have computer instructions for monitoring in a communication system activities associated with a plurality of communication devices of an end user operating therein, and transmitting a notice when a change in the monitored activities differs from a behavior expected of the end user.

In a third embodiment of the present disclosure, a method in a communication device can include the steps of sharing behavioral information associated with an end user of the communication device with an activity notification system (ANS) that detects anomalous changes in the behavioral information.

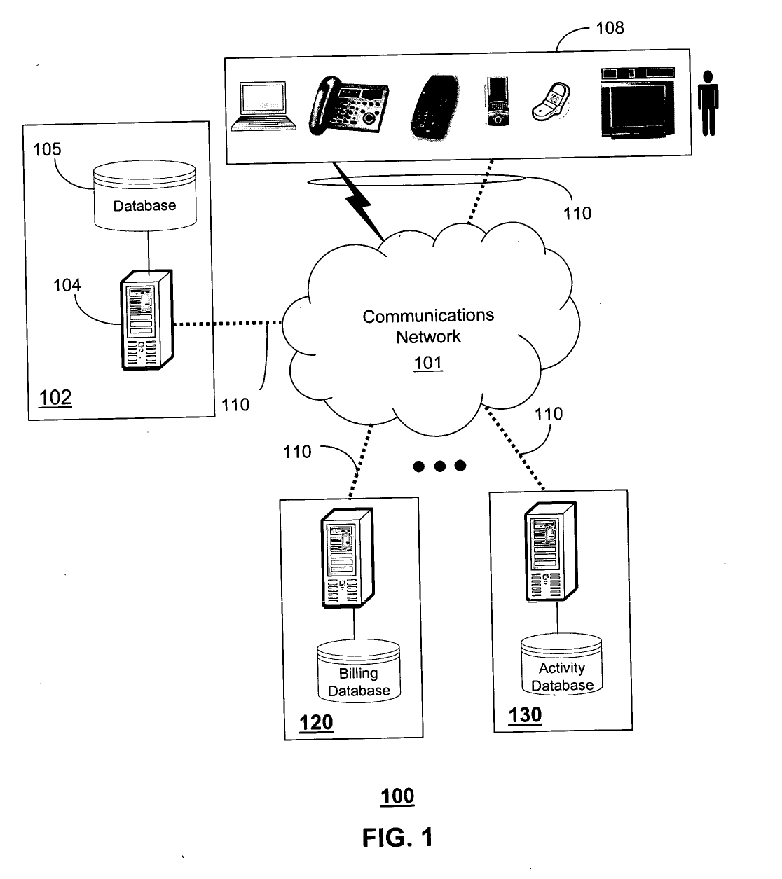

FIG. 1 depicts an exemplary embodiment of an activity notification system (ANS) 102 monitoring anomalous behavior of one or more communication devices 108 of an end user operating in a communication system 100. The ANS 102 can comprise a communications interface 110, a memory 105 and a controller 104. The communications interface 110 can use common wired or wireless communications technology for interfacing to a communications network 101 that can support circuit switched and/or a packet switched communications. The communications network 101 can offer communication devices 108 Internet and/or traditional voice and data services such as, for example, POTS (Plain Old Telephone Service), VoIP (Voice over Internet communications, IPTV (Internet Protocol Television), broadband communications, cellular telephony, WiMAX, WiFi, Bluetooth™, as well as other present and next generation access technologies.

The controller 104 of the ANS 102 can utilize common computing technology such as a desktop computer, or scalable server. The memory 105 can include mass storage media such as a high capacity disk drive that can be used by the controller 104 to manage one or more databases for manipulating an end user profile according to the present disclosure. The controller 104 can be programmed to access by way of the communications network 101 independently operated common technologies such as a billing system 120 and/or activity tracking system 130 for tracking service consumption and network activities associated with an end user of the communication devices 108. In an alternative embodiment, these systems can be an integral part of the ANS 102 managed by controller 104.

The communication devices 108 can represent any number of embodiments including, for example, a laptop or desktop computer, a telephone managed by a base unit, a credit card reader, a personal digital assistance (PDA), a cellular phone, or a television set with an associated IPTV-capable set top box or residential gateway (separately or integrated therein). Some or all of these devices can interface to the communication network 101 with a wired or wireless interface. For example, the laptop can be interconnected to the communications network 101 by a wired Ethernet port to a DSL (Digital Service Line) interface in a residence or enterprise, or by a WiFi or WiMAX wireless connection.

The telephone and base unit can utilize cordless 2.4 GHz or 5.8 GHz technology for short-range roaming, and an interface to the communications network by way of POTS or VoIP communications. A credit card reader can interface to the communications network 101 with a POTS interface. The PDA and cellular phone can support common cellular and WiFi access technologies for interfacing to the communications network 101. The set top box or residential gateway can connect to a cable or fiber optic interface that supports IPTV services by way of the communications network.

Any number of the aforementioned communication devices in FIG. 1 can also be combined so as to create a multifunctional communication device. For example, VoIP, over-the-air paging, email and calendaring, and cellular communication functionality can be integrated into the PDA.

Each these communication device can comprise a wired and/or wireless transceiver, a user interface (UI), a power supply, and a controller for managing operations thereof. In an embodiment where the communication devices 108 operate in a landline environment, the transceiver would utilize common wireline access technology to support POTS or VoIP services. In a wireless communications setting, the transceiver can utilize common technologies to support singly or in combination wireless access technologies including without limitation cordless technologies, Bluetooth™, Wireless Fidelity (WiFi), Worldwide Interoperability for Microwave Access (WiMAX), Ultra Wide Band (UWB), software defined radio (SDR), and cellular access technologies such as CDMA-1X, W-CDMA/HSDPA, GSM/GPRS, TDMA/EDGE, and EVDO. SDR can be utilized for accessing a public or private communication spectrum according to a number of communication protocols that can be dynamically downloaded over-the-air to the communication device 108.

The UI of the communication device 108 can include a keypad with depressible or touch sensitive navigation disk and keys for manipulating operations of the communication device. The UI can further include a display such as monochrome or color LCD (Liquid Crystal Display) for conveying images to the end user of the communication device, and an audio system for conveying and intercepting audible signals of the end user.

The power supply can utilize common power management technologies such as replaceable batteries, supply regulation technologies, and charging system technologies for supplying energy to the components of the communication device and to facilitate portable applications. In stationary applications, the power supply can be modified so as to extract energy from a common wall outlet and thereby supply DC power to the components of the communication device.

The controller of the communication device 108 can utilize computing technologies such as a microprocessor and/or digital signal processor (DSP) with associated storage memory such a Flash, ROM, RAM, SRAM, DRAM or other like technologies for controlling operations of the aforementioned components of the communication device.

With the exception of the credit card reader, one or more of the foregoing communication devices 108 can be carried on an on-going basis by an end user. The credit card reader will generally be in the possession of a retailer for processing product sales on credit. When an end user makes purchase transactions on such a device, the transaction can be carried by the communications network 101 to a billing system such as 120 which may be operated independently from the ANS 102. Agreements may be required between the service providers of the ANS 102 and billing system 120 to conduct information sharing for the purposes presented in this disclosure. The activity tracking system 130 can also be independently operated as a clearing house for activities monitored in the communication network 101 across independent services providers. Accordingly, an agreement may also be required for information access by the ANS 102 to system 130.

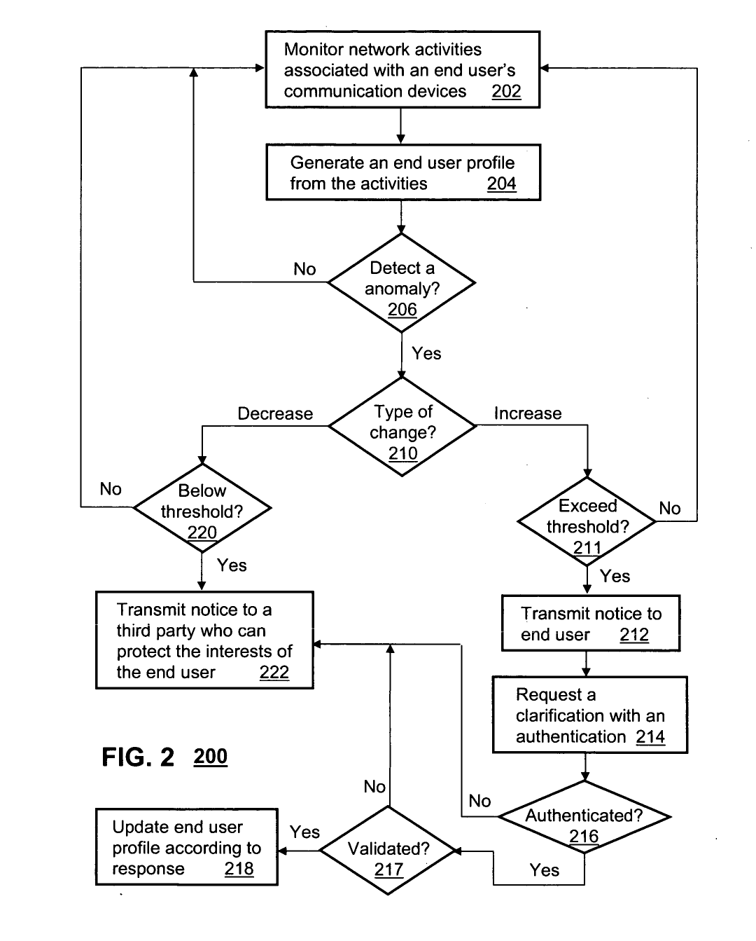

FIG. 2 depicts an exemplary method 200 operating in the ANS 102 and the monitored communication devices 108. Method 200 begins with step 202 where the controller 104 of the ANS 102 monitors network activities associated the communication devices 108. The network activities originate in part from the end user's interactions with the communication devices 108. In the present context, a network activity can comprise a number of communication activities originating or terminating at the communication devices 108 by way of the communications network 101.

For example, egress or ingress data traffic for each of the communication devices 108 can be tracked by the ANS 102 at a number of elements (routers, gateways, etc.) of the communications network 101. In a more specific case, purchases fulfilled by the end user can be observed by the ANS 102 (with the appropriate authorizations) when the end user utilizes a credit card reader, or makes electronic purchases on the Internet. Similarly, outgoing and incoming POTS or VoIP wireless or wireline calls transacted by the end user on any one of the communication devices 108 can be monitored. Internet usage such as web browsing can be monitored from one or more elements of the communications network 101. In geographic areas where broadband services are offered, multimedia services such as IPTV along with programming selections made by the end user can also be monitored by the ANS 102. Additionally, network activity can constitute location information such as a GPS (Global Position System) reading supplied by one of the communication devices 108, or derived from network elements (such as base stations) tracking a roaming communication device in a cellular system.

The aforementioned network activities can be monitored in part according to signaling protocols operating in the communications network 101. Such protocols can include, for example, SIP (Session Initiation Protocol), Signaling System 7 (SS7), and Advanced Intelligent Network (AIN).

In step 204, the controller 104 can be programmed to generate from the monitored activities an end user profile that predicts a behavior of the end user. The end user profile can operate according to any statistical, probabilistic, or analytical model (such as linear regression or Bayes'theorem) for predicting the end user's behavior according to the network activities monitored. The end user profile can therefore be used to detect anomalous events such as an unexpected or excessive activity of the end user (e.g., too many credit card charges in one day, running high charges for cellular phone calls or long distance landline calls, etc.). Similarly, the end user profile can be used by the controller 104 to detect an unusual low activity level of the end user (e.g., failed to answer calls for one or more days, IPTV programming on for an excessive period of time, etc.). The more monitoring of the end user that takes place the more precise the predictions derived from the end user profile can be. An end user profile can be tailored specifically to each end user monitored by the controller 104. Accordingly, the predictions made by one end user profile may not necessarily be the same as the predictions made by another.

With this in mind, the controller 104 can be programmed to detect in step 206 anomalous behavior when inconsistencies are detected between the activities monitored and the predictions made by the end user profile. If no anomalies are detected, the controller 104 proceeds to steps 202-204, thereby repeating the monitoring process and making updates to the end user profile as the patterns of behavior of the end user moderately change. If an anomaly is detected, the controller 104 can be programmed in step 210 to distinguish between unexpected decreases in activities of the end user versus excessive ones. To avoid false-positive triggers in either case, the controller 104 can be programmed in steps 220 or 211 to compare a decrease or increase to a corresponding threshold. These thresholds can be established by the administrator of the ANS 102 according to guidelines provided by the end user, a guardian of the end user, or according to analytical models designed to reduce false-positives.

If a decrease in activities is detected but it is above the threshold of step 220, the controller 104 can be directed to ignore the anomaly and return to the monitoring process starting from step 202. If, however, the decrease falls below the threshold, the controller 104 proceeds to step 222 where it transmits a notice to a third party who can protect the interests of the end user. This third party can be someone identified by the end user for circumstances such as these, a guardian or custodian of the end user, a family member, an associate of the end user, an emergency service, and/or local law enforcement. For elderly individuals using the services of the ANS 102, a lack of activities may be an indication that the end user may be in danger (e.g., forgot to take medication, is ill, etc.). For such users the threshold can be set to a high sensitivity level to minimize a delay in responding to the needs of the end user. At such sensitivities, false-positives may occur more frequently.

The notice submitted in step 222 can be transmitted in an email, a short message service (SMS) message, or a voice call. For voice calls, the call can be made by a human agent managing an aspect of operations of the ANS 102, or according to a common interactive voice response service (IVR) operating in the controller 104. The IVR can, for example, utilized synthesized voice technology to inform the party identified in step 222 of its observations of the end user's behavior. The IVR can request instructions from the called party or provide options such as calling emergency personnel (fire rescue), law enforcement, and/or directing a call to the end user. Response from the called party can be detected by the IVR application using voice recognition and DTMF tone detection techniques.

If, on the other hand, the change detected in step 210 is an increase in activities, but such change falls short of exceeding the threshold established in step 211, the controller 104 discounts the anomaly and proceeds to step 202 continuing the monitoring process. If the increase exceeds the threshold of step 211, the controller 104 proceeds to step 212 where it transmits a notice to the end user. Similar to step 222, the notice can be an email, an SMS message or voice call by way of a human agent or the IVR application operating in the controller 104. For security reasons, the controller 104 can request in step 214 a clarification of the anomalous activities along with an authentication request. The authentication request can be a personal identification number (PIN), usemame and/or password, or any other form of authentication means. The authentication can be recognized by the controller 104 using IVR recognition techniques, a reply email or reply SMS message.

If the end user fails to respond within an allotted response time, or does not provide appropriate authentication information in step 216, the controller 104 proceeds to step 222, thereby notifying an interested party as described earlier. If, however, the end user is successfully authenticated, the controller 104 proceeds to step 217 where it checks for a validation from the end user as to the correctness of the activities. If the end user validates that the activities are his and no action should be taken, then the controller 104 proceeds to step 218 where it updates the end user profile to account for this exception. If the end user invalidates some or all of the detected anomalies, the controller 104 can be programmed to proceed to step 222 as described above.

The foregoing steps can be triggered, for example, in cases where the end user makes unusually large purchases (e.g., a computer or furniture). In cases such as this, the end user can be notified of the possibility of fraudulent activities as they may arise in real or near real-time. Similarly, these steps can be triggered by excessive egress data traffic detected on the end user's IP-capable communication devices 108 such as a computer, or IPTV residential gateway or set top box. The excessive traffic may be an indication that the end user's communication devices 108 have been infected by a computer virus or other dangerous event. For either of these examples, the controller 104 can be directed by the end user from step 217 to call a specific party in step 222. In the first example, such party may be a law enforcement agency or agent. In the latter example, the party called may be a technical help desk of the service provider offering Internet and/or IPTV services.

It would be evident to one of ordinary skill in the art that innumerable enhancements and/or modifications can be made to the present disclosure without departing from the spirit and scope of the claims described below.

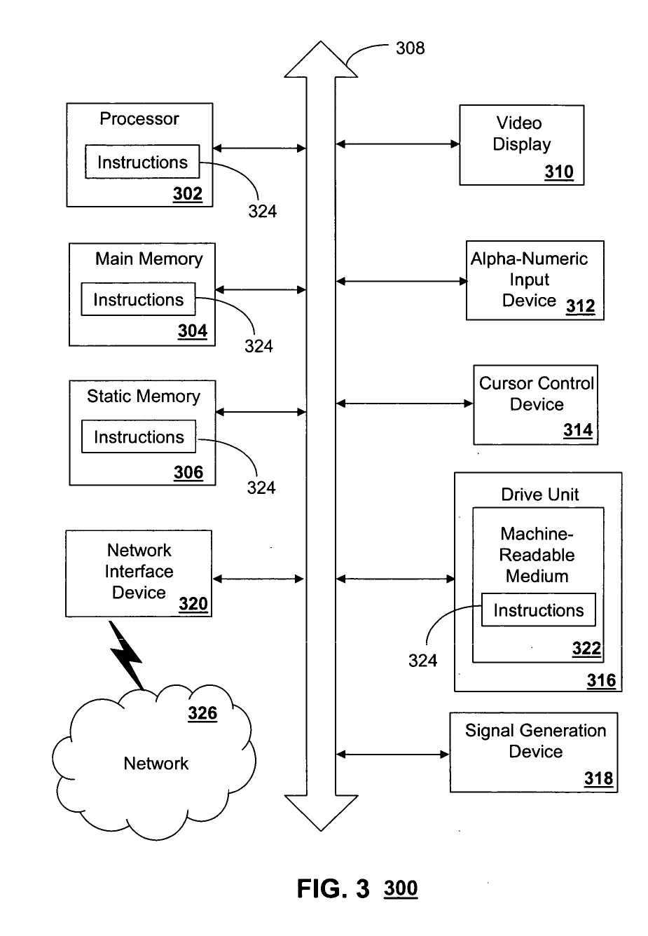

FIG. 3 depicts an exemplary diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An activity notification system (ANS), comprising:
a controller that manages operations of a communications interface to communicate with network elements in a communication system, wherein the controller is programmed to:
monitor network activities associated with a plurality communication devices of an end user;
generate from the monitored activities an end user profile that predicts a behavior of the end user; and
transmit a notice when a change in the monitored activities differs from a behavior predicted by the end user profile.

2. The ANS of claim 1, wherein the controller is programmed to transmit the notice to at least one among the end user, a family member of the end user, someone associated with the end user, an emergency service, a law enforcement service, and someone identified by the end user.

3. The ANS of claim 1, wherein the controller is programmed to transmit the notice to at least one among an emergency service, and someone identified by the end user when the change in the monitored activities shows a noticeable decrease in activities when compared to the behavior predicted by the end user profile.

4. The ANS of claim 1, wherein the controller is programmed to transmit the notice to the end user when the change in the monitored activities shows a noticeable increase in activities when compared to the behavior predicted by the end user profile.

5. The ANS of claim 1, wherein the activities monitored for each of the one or more communication devices comprise at least one among egress data traffic, ingress data traffic, purchases fulfilled by the end user, outgoing calls initiated, incoming calls accepted, Internet usage, and multimedia program selections.

6. The ANS of claim 1, wherein the monitored activities comprise signaling control information, and wherein the controller is programmed to generate the end user profile from monitoring the signaling control information associated with the one or more communication devices of the end user.

7. The ANS of claim 1, wherein the signaling control information comprises at least one among a group of protocols comprising SIP (Session Initiation Protocol), Signaling System 7 (SS7), and Advanced Intelligent Network (AIN).

8. The ANS of claim 1, wherein the one or more communication devices comprise at least one among a telephony device, a computer, and an Internet Protocol TV (IPTV) device, and wherein the communication system supports at least one among Voice over IP (VoIP) services, Plain Old Telephone Services (POTS), IPTV services, and wireless communication services.

9. The ANS of claim 1, wherein the controller is programmed to transmit the notice in at least one among a group of message formats comprising an email, a short message service (SMS) message, and a telecommunications call.

10. The ANS of claim 1, wherein the controller is programmed to:
initiate a call to a communication device of a party;
transmit a voice message corresponding to the notice upon acceptance of the call by the party; and
receive a response from the party.

11. The ANS of claim 10, wherein the controller is programmed to update the end user profile according to the response once an identification supplied in said response has been authenticated.

12. The ANS of claim 10, wherein the controller is programmed to:
update the end user profile upon receiving in the response a validation of the change in activities monitored; and
transmit the notice to a guardian upon receiving in the response an invalidation of the change in activities monitored.

13. A computer-readable storage medium in an activity notification system (ANS), comprising computer instructions for:
monitoring in a communication system activities associated with a plurality communication devices of an end user operating therein; and
transmitting a notice when a change in the monitored activities differs from a behavior expected of the end user.

14. The storage medium of claim 13, comprising computer instructions for transmitting the notice to a guardian when the change in monitored activities falls below a threshold associated with the expected behavior of the end user.

15. The storage medium of claim 13, comprising computer instructions for transmitting the notice to the end user when the change in monitored activities exceeds a threshold associated with the expected behavior of the end user.

16. The storage medium of claim 13, comprising computer instructions for transmitting the notice to one of the communication devices of the end user, wherein the notice comprises as a voice message describing the change detected and a request for a clarification response from the end user.

17. The storage medium of claim 16, comprising computer instructions for receiving the response from the end user, wherein the response comprises one among one or more Dual Tone Multi Frequency (DTMF) tones entered by the end user, and a voice response from the end user.

18. The storage medium of claim 16, comprising computer instructions for:
detecting no response from the end user within an allotted response time; and
transmitting the notice to a communication of an alternate third party.

19. A method in a communication device, comprising sharing behavioral information associated with an end user of the communication device with an activity notification system (ANS) that detects anomalous changes in the behavioral information.

20. The method of claim 19, comprising receiving a notice from the ANS requesting a clarification on anomalous changes detected in the behavioral information.

21. The method of claim 19, wherein the behavioral information comprises at least one among a location of the end user, and operations of the communication device manipulated by the end user.
